(19) United States
(12) Patent Application Publication
(10) Pub. No.: US 2015/0271014 A1
(43) Pub. Date: Sep. 24, 2015

(54) AUTOMATIC CONFIGURATION OF NEW COMPONENTS BY INFRASTRUCTURE MANAGEMENT SOFTWARE

(71) Applicant: ONYX CCS, Brookfield, CT (US)

(72) Inventor: Alexander Madama, Brookfield, CT (US)

(21) Appl. No.: 14/665,334

(22) Filed: Mar. 23, 2015

Related U.S. Application Data
(60) Provisional application No. 61/968,692, filed on Mar. 21, 2014.

(51) Int. Cl. H04L 12/24; H04L 29/08

(52) U.S. Cl. CPC H04L 41/0806; H04L 67/10

(57) ABSTRACT

A method for managing a cluster of nodes in a networked system includes detecting the presence of a new node as it is added into the network. A hardware configuration of the new node is automatically determined. A role is assigned to the new node based on the determined new node's configuration and according to predefined node configuration criteria. The new node is selectively configured based on the assigned role.

### CROSS REFERENCE TO RELATED APPLICATIONS

This application claims priority to U.S. Patent Application Ser. No. 61/968,692 filed Mar. 21, 2014 which is incorporated by reference in its entirety.

### FIELD OF THE INVENTION

The present invention generally relates to Infrastructure-as-a-Service software, and, more particularly, to automatic configuration of new components by infrastructure management software.

### BACKGROUND OF THE INVENTION

Infrastructure as a Service (“IaaS”) cloud management software typically manages a set of hardware as a pool of resources and performs allocation and de-allocation of resources to or from the pre-defined pool. The resources often include a virtual physical server (including CPU, memory, storage) and network, although a wide variety of other hardware and services are possible. The resources are often installed as large pools in a data center which can be either local or remote to the end user. The IaaS cloud management software also optionally includes a set of administrative and end user capabilities, and builds on a service driven model like service request management, process automation through workflows, and notification.

Service providers offer IaaS services to clients who purchase these services on a fixed fee or pay-as-you-go. The clients can access the IaaS services via the Internet, virtual networks, and/or local area networks.

Setting up IaaS cloud management software typically requires a managed infrastructure including physical servers, storage and networking, etc. Often, the IaaS cloud management software might not be sufficient unless there is a minimum set of managed hardware for the resource pool. There are several key challenges faced during the life cycle of IaaS software development, including but not limited to: (i) requiring highly skilled resources to perform the setup and configuration of the managed hardware and software; (ii) the substantial amount of time required to prepare and configure the hardware and software; and (iii) the extensive testing that is consistently required in order to make the software stable and deliver expected results.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

The embodiments of the present invention are directed to improved methods, apparatus and system for managing a cluster of nodes in a networked system. The improved method includes detecting the presence of a new node as it is added into the network. A hardware configuration of the new node is automatically determined. A role is assigned to the new node based on the determined new node's configuration and according to predefined node configuration criteria. The new node is selectively configured based on the assigned role.

According to an aspect of the present invention, after a hardware configuration of the new node is automatically determined, a position of the new node within the networked cluster is identified based on analysis of information related to one or more adjacent nodes within the networked cluster.

According to another aspect, remote initialization of the new node is performed in response to receiving a Preboot eXecution Environment (PXE) boot image request from the new node, after detecting the presence of the new node.

In another aspect, the computer system for distributed management of a cluster of nodes includes a network configured to communicate data between a plurality of nodes. The system further includes one or more new nodes and one or more cluster management nodes in communication with the network. The cluster management nodes include a hardware analyzing module, role managing module and node naming module. The hardware analyzing module is configured to analyze hardware configurations of the plurality of nodes and hardware configurations of the one or more new nodes. The role managing module is configured to determine at least one role for the new nodes based on the configurations of the new nodes. The node naming module is configured to dynamically assign a descriptive name to the new nodes based at least in part on the at least one role assigned to the one or more new nodes.

According to an aspect, the computer system further includes a configuration management repository for storing the configuration information related to the plurality of nodes. The plurality of nodes includes the new nodes.

According to another aspect, the configuration managing module utilizes one or more user-configurable configuration scripts. The configuration scripts include a plurality of configuration parameters and settings related to the at least one assigned role of the one or more new nodes.

According to yet another aspect, the descriptive name is assigned to the one or more new nodes according to a predefined node naming convention. The assigned name is indicative of the role and physical location of the one or more new nodes within the cluster of nodes.

In yet another aspect, the computer program product for distributed management of a cluster of nodes includes a computer readable storage device to store a plurality of program instructions. The plurality of program instructions, when executed by a processor within one or more cluster management nodes, causes the one or more cluster management nodes to perform operations of a plurality of modules. The modules include a hardware analyzing module, role managing module, node naming module and a configuration managing module. The hardware analyzing module is configured to analyze hardware configurations of the plurality of nodes and hardware configurations of the one or more new nodes. The role managing module is configured to determine at least one role for the new nodes based on the configurations of the new nodes. The node naming module is configured to dynamically assign a descriptive name to the new nodes based at least in part on the at least one role assigned to the one or more new nodes. The configuration managing module is configured to selectively configure the one or more new nodes based on the at least one assigned role.

### BRIEF DESCRIPTION OF THE DRAWINGS

The accompanying appendices and/or drawings illustrate various non-limiting, examples, inventive aspects in accordance with the present disclosure:

FIG. 1A illustrates a network system configured in accordance with an embodiment of the present invention;

FIG. 1B illustrates a cloud computing environment in accordance with an embodiment of the present invention;

FIG. 2A is a block diagram of a model of IaaS management software with managed infrastructure in accordance with an exemplary embodiment of the present invention;

FIG. 2B is a block diagram of dataflow of IaaS management software in accordance with an exemplary embodiment of the present invention;

FIG. 3 illustrates a physical layout of an exemplary managed infrastructure of FIGS. 2A and 2B comprising a complete software defined data center in accordance with certain illustrated embodiments of the present invention;

FIG. 4 is a flowchart of operational steps of the infrastructure manager component of FIGS. 2A and 2B in accordance with an exemplary embodiment of the present invention;

FIG. 5 is a flowchart of operational steps of the hardware analyzer component of FIGS. 2A and 2B in accordance with an exemplary embodiment of the present invention;

FIG. 6 is a flowchart of operational steps of the role manager component of FIGS. 2A and 2B in accordance with an exemplary embodiment of the present invention; and

FIG. 7 illustrates a hardware configuration of a seed node configured in accordance with an exemplary embodiment of the present invention.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described below. One skilled in the art will appreciate further features and advantages of the illustrated embodiments based on the below-described embodiments. Accordingly, the illustrated embodiments are not to be limited by what has been particularly shown and described, except as indicated by the appended claims.

The present invention comprises a method, system and computer product for managing and deploying physical and virtual environments across multiple hardware platforms. In one embodiment of the present invention, a single unit, referred to herein as a seed node, contains both the hardware and software components used to build a clustered networked infrastructure, such as cloud computing environment, by automatically configuring new components managed by infrastructure management software. Furthermore, the managed infrastructure contains modular pieces of hardware, such as computing hardware, memory hardware, storage hardware and network hardware that are integrated with the infrastructure management software to deploy and manage new infrastructure components in a seamlessly integrated fashion. Advantageously, the infrastructure management software described herein allows the user to easily scale and manage thousands of the modular pieces of hardware if desired.

It is understood in advance that although this disclosure includes a detailed description on cloud computing, implementation of the teachings recited herein are not limited to a cloud computing environment. Rather, the embodiments of the present invention are capable of being implemented in conjunction with any type of clustered computing environment now known or later developed.

Cloud computing is a model for enabling convenient, on-demand network access to a shared pool of configurable computing resources (e.g., networks, servers, storage, applications, and services) that can be rapidly provisioned and released with minimal management effort or service provider interaction. This cloud model is composed of five essential characteristics, three service models, and four deployment models.

Characteristics are as follows:

On-Demand Self-Service: A consumer can unilaterally provision computing capabilities, such as server time and network storage, as needed, automatically without requiring human interaction with each service's provider.

Broad Network Access: Capabilities are available over a network and accessed through standard mechanisms that promote use by heterogeneous thin or thick client platforms (e.g., mobile phones, tablets, laptops and workstations).

Resource Pooling: The provider's computing resources are pooled to serve multiple consumers using a multi-tenant model, with different physical and virtual resources dynamically assigned and reassigned according to consumer demand. There is a sense of location independence in that the consumer generally has no control or knowledge over the exact location of the provided resources but may be able to specify location at a higher level of abstraction (e.g., country, state or data center). Examples of resources include storage, processing, memory and network bandwidth.

Rapid Elasticity: Capabilities can be elastically provisioned and released, in some cases automatically, to scale rapidly outward and inward commensurate with demand. To the consumer, the capabilities available for provisioning often appear to be unlimited and can be purchased in any quantity at any time.

Measured Service: Cloud systems automatically control and optimize resource use by leveraging a metering capability at some level of abstraction appropriate to the type of service (e.g., storage, processing, bandwidth and active user accounts). Resource usage can be monitored, controlled and reported providing transparency for both the provider and consumer of the utilized service.

Service Models are as follows:

Software as a Service (SaaS): The capability provided to the consumer is to use the provider's applications running on a cloud infrastructure. The applications are accessible from various client devices through either a thin client interface, such as a web browser (e.g., web-based e-mail) or a program interface. The consumer does not manage or control the underlying cloud infrastructure including network, servers, operating systems, storage, or even individual application capabilities, with the possible exception of limited user-specific application configuration settings.

Platform as a Service (PaaS): The capability provided to the consumer is to deploy onto the cloud infrastructure consumer-created or acquired applications created using programming languages, libraries, services and tools supported by the provider. The consumer does not manage or control the underlying cloud infrastructure including networks, servers, operating systems or storage, but has control over the deployed applications and possibly configuration settings for the application-hosting environment.

Infrastructure as a Service (IaaS): The capability provided to the consumer is to provision processing, storage, networks and other fundamental computing resources where the consumer is able to deploy and run arbitrary software, which can include operating systems and applications. The consumer does not manage or control the underlying cloud infrastructure but has control over operating systems, storage and deployed applications; and possibly limited control of select networking components (e.g., host firewalls).

Deployment Models are as follows:

Private Cloud: The cloud infrastructure is provisioned for exclusive use by a single organization comprising multiple consumers (e.g., business units). It may be owned, managed and operated by the organization, a third party or some combination of them, and it may exist on or off premises.

Community Cloud: The cloud infrastructure is provisioned for exclusive use by a specific community of consumers from organizations that have shared concerns (e.g., mission, security requirements, policy and compliance considerations). It may be owned, managed and operated by one or more of the organizations in the community, a third party, or some combination of them, and it may exist on or off premises.

Public Cloud: The cloud infrastructure is provisioned for open use by the general public. It may be owned, managed and operated by a business, academic or government organization, or some combination of them. It exists on the premises of the cloud provider.

Hybrid Cloud: The cloud infrastructure is a composition of two or more distinct cloud infrastructures (private, community or public) that remain unique entities, but are bound together by standardized or proprietary technology that enables data and application portability (e.g., cloud bursting for load balancing between clouds).

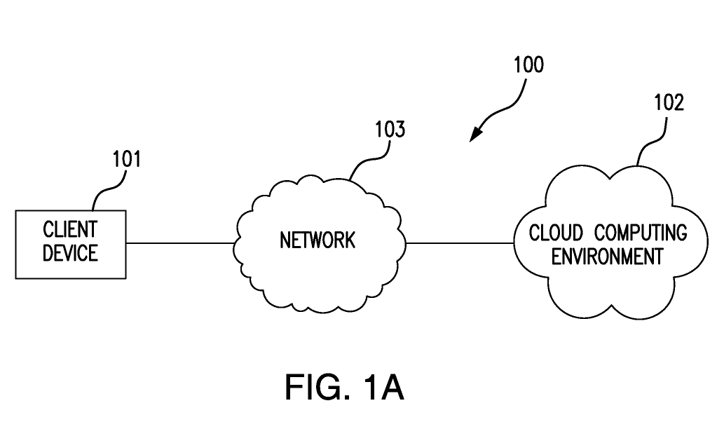

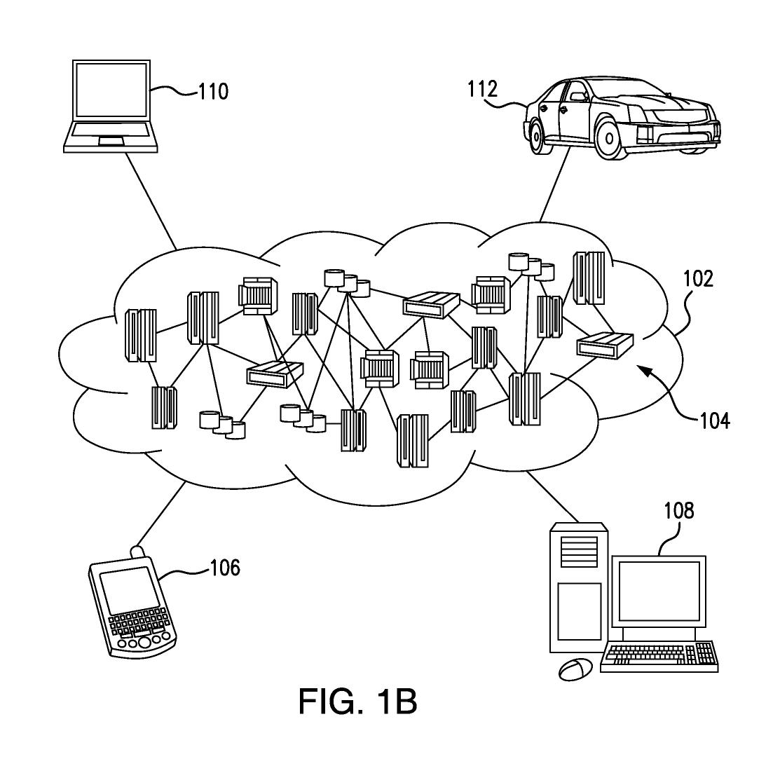

Referring now to the Figures in detail, FIG. 1A illustrates a network system 100 configured in accordance with an embodiment of the present invention. Network system 100 includes a client device 101 connected to a managed infrastructure 102, such as cloud computing environment, via a network 103. Client device 101 may be any type of computing device (e.g., portable computing unit, personal digital assistant (PDA), smartphone, laptop computer, mobile phone, navigation device, game console, desktop computer system, workstation, Internet appliance and the like) configured with the capability of connecting to cloud computing environment 102 via network 103.

Network 103 may be, for example, a local area network (LAN), a wide area network (WAN), a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

Managed infrastructure 102 is used to deliver computing as a service to client device 101 implementing the model discussed above. An embodiment of managed infrastructure, more specifically cloud computing environment 102, is discussed below in connection with FIG. 1B.

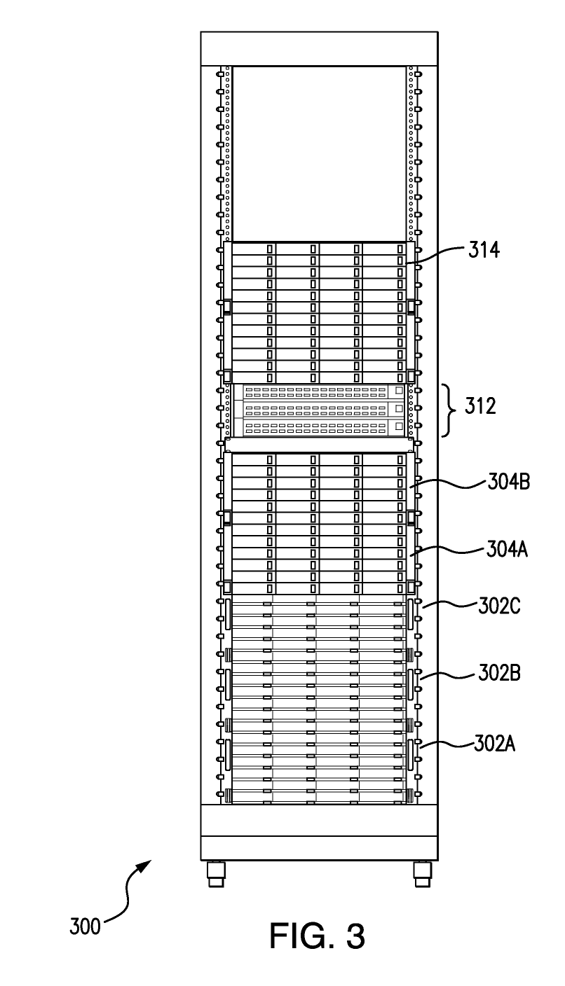

FIG. 1B illustrates cloud computing environment 102 in accordance with an embodiment of the present invention. As shown, cloud computing environment 102 includes one or more cloud computing nodes 104 with which local computing devices used by cloud consumers, such as, for example, personal digital assistant (PDA) or cellular telephone 106, desktop computer 108, laptop computer 110, and/or automobile computer system 112 may communicate. Nodes 104 may communicate with one another. They may be grouped (not shown) physically or virtually, in one or more networks, such as Private, Community, Public, or Hybrid clouds, or a combination thereof. This allows cloud computing environment 102 to offer infrastructure, platforms and/or software as services for which a cloud consumer does not need to maintain resources on a local computing device. A description of a schematic of a physical layout of an exemplary software defined data center implemented as a cloud computing environment 102 is provided below in connection with FIG. 3.

It is understood that the types of computing devices 106, 108, 110, 112 shown in FIG. 1B, which may represent client device 101 of FIG. 1A, are intended to be illustrative and that cloud computing nodes 104 and cloud computing environment 102 can communicate with any type of computerized device over any type of network and/or network addressable connection (e.g., using a web browser).

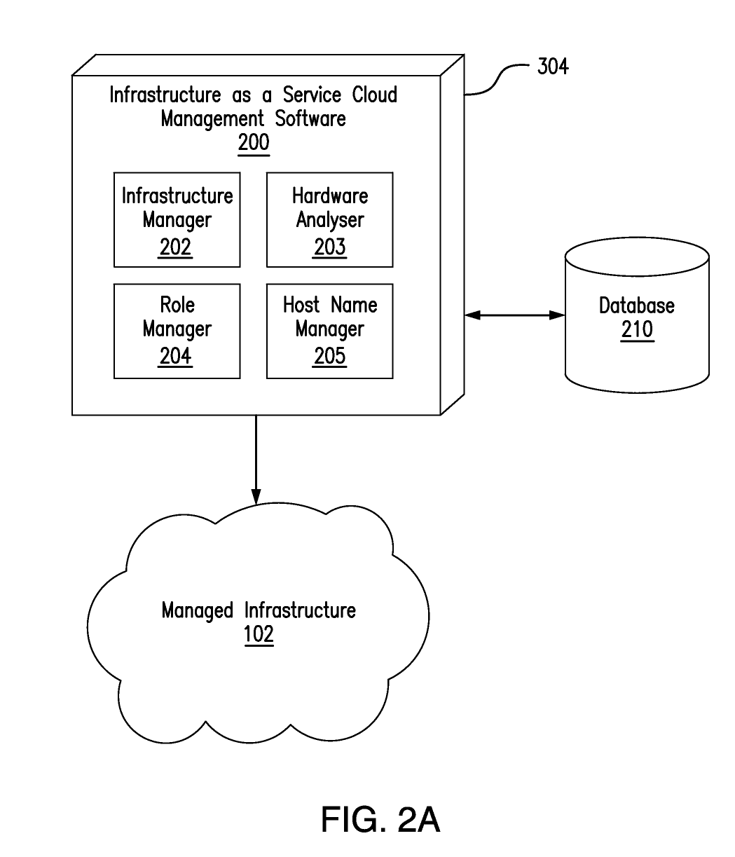

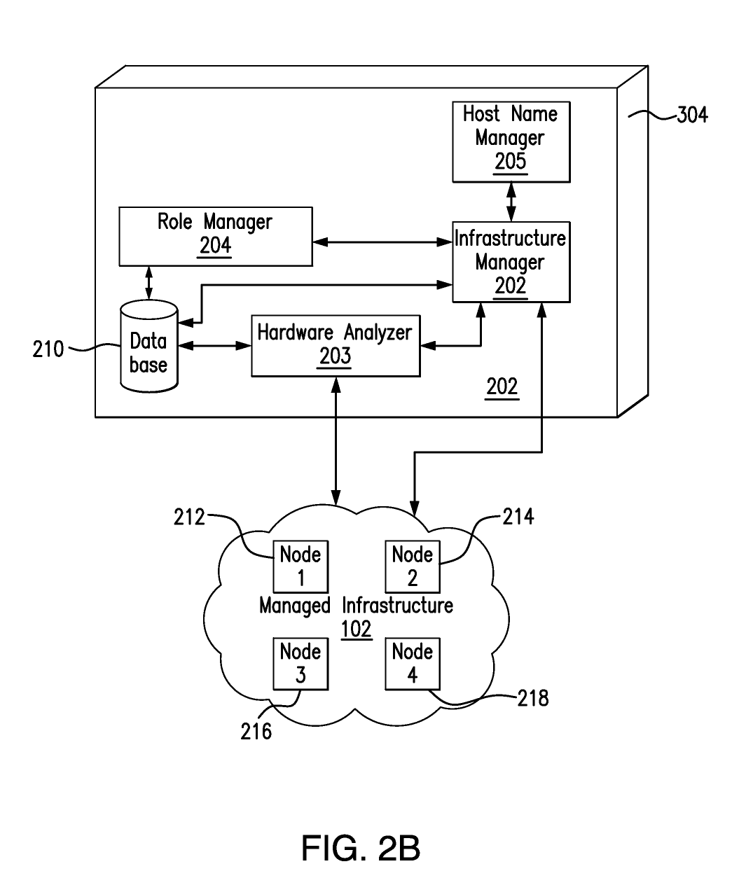

Referring now to FIG. 2A, FIG. 2A depicts an exemplary model of IaaS management software 200 with its managed infrastructure as a pool of resources (e.g., cloud computing environment) 102. IaaS software 200 can have multiple components, such as components 202 through 205 depicted in FIG. 2A. According to an embodiment of the present invention, examples of IaaS software components include, but are not limited to, an infrastructure manager 202, hardware analyzer 203, role manager 204, and a host name manager 205. Infrastructure manager 202 is a component configured to manage both interaction between the components 202-205 and interaction with the managed infrastructure 102. Hardware analyzer 203 is a component configured to analyze hardware configuration of various nodes 104 within the managed infrastructure 102. Role manager 204 is a component configured to determine a role of the newly installed node based on its configuration and according to predefined node configuration criteria. Host name manager 205 is a component configured to dynamically assign a descriptive name within the infrastructure namespace, as described below. Many other types of components are possible.

Typically, IaaS software 200 will be associated with one or more databases 210 to save details about the resource pool, including information about infrastructure, usage, allocation, de-allocation, and many other facets of the resource pool. For example, according to an embodiment of the present invention, IaaS management software 200 can be associated with a change and configuration management database, a data center model database, and/or many other types of databases.

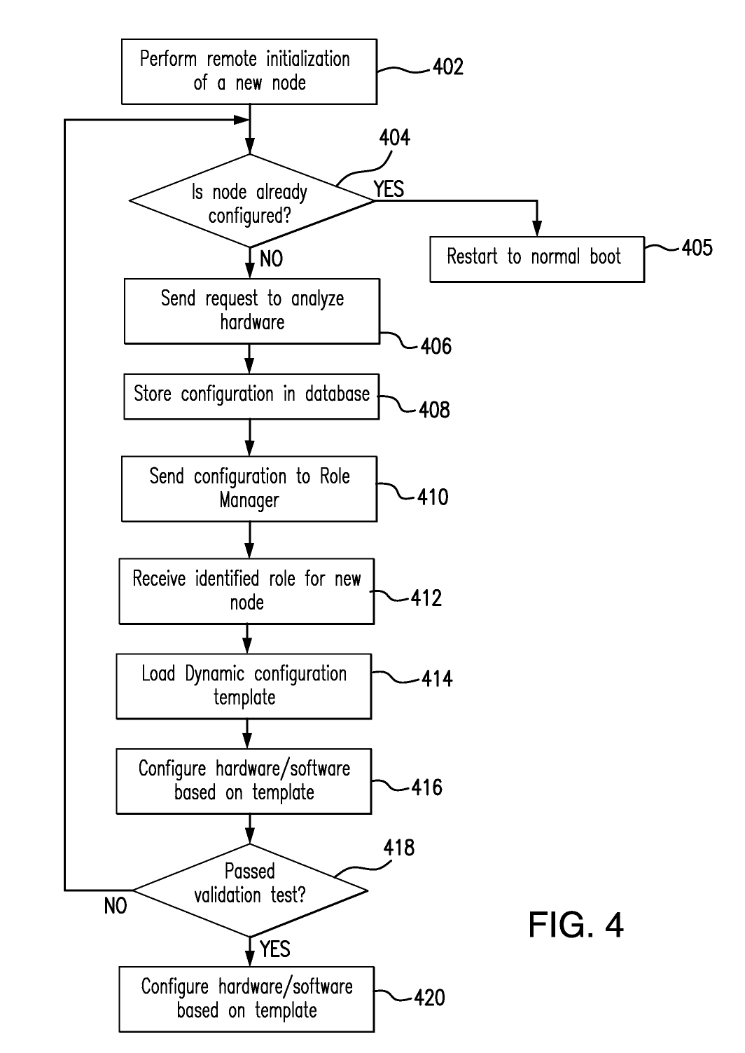

FIG. 2B depicts an exemplary dataflow where at least an infrastructure manager 202 and hardware analyzer 203 interact with the managed infrastructure 102. “Dataflow” can include, but is not limited to, forms of communication used in parallel computing and/or object oriented programming in which information is sent to and received from other processes. Dataflow management can be especially important in systems that provide high-performance and/or continuous processing via concentrated data streams. Detailed description of exemplary operational steps and interaction between components 202-205 related to infrastructure discovery and automatic configuration of new nodes within the managed infrastructure 102 is provided below in reference to FIGS. 4-6. According to an embodiment of the present invention, all components 202-205 and one or more databases 210 may be configured to run on a single seed node 201. According to an alternative embodiment, components 202-205 and one or more databases 210 may be distributed between two or more seed nodes 201.

It is understood that in various embodiments of the present invention, managed infrastructure 102 may comprise a complete and scalable software defined data center. Though only four nodes 212-218 are depicted in FIG. 2B, managed infrastructure 102 may comprise any number of nodes.

FIG. 3 illustrates a physical layout of an exemplary software defined data center 300 in accordance with an embodiment of the present invention. Referring to FIG. 3, cloud based data center 300 may comprise a rack of many units containing network hardware (e.g., network switches 312), storage hardware (e.g., disk arrays 302A, 302B, 302C), and compute hardware (e.g., a plurality of compute nodes 314). Disk arrays 302A-302C may collectively or individually be referred to as storage nodes 302 or storage node 302, respectively.

Managed data center 300 may further include one or more seed nodes 304A-304B with memory configured to store software referred to herein as IaaS management software 200. Seed nodes 304A-304B may collectively or individually be referred to as seed nodes 304 or seed node 304, respectively. IaaS management software 200 is configured to manage and automate all aspects of the cloud computing system (for example, comprised of one or more data centers 300) both physical and virtual as discussed further herein in connection with FIGS. 4-6. Additionally, managed data center 300 may include one or more power distribution units (not shown in FIG. 3).

While FIG. 3 illustrates a software defined data center 300 as comprising one rack containing a particular number of network switches 312, storage nodes 302, compute nodes 314, seed nodes 304, the managed environment depicted as data center 300 is not to be limited in scope to the particular number of racks and the particular number of components (nodes) depicted in FIG. 3. Managed infrastructure may include any number of components used to support the network hardware, storage hardware, compute hardware and memory hardware and may include any number of seed nodes 304 to configure and manage the operation of one or more managed data centers 300 to form the clustered network computing environment.

Advantageously, an automatically configurable environment described herein facilitates rapid and nearly unlimited scalability (either up or down) without significantly affecting corresponding costs. In some cases, entire data centers may be configured in a matter of minutes rather than several days or longer.

FIGS. 4-6 are flowcharts of operational steps of the infrastructure manager 202, hardware analyzer 203 and role manager 204 components of FIGS. 2A-2B in accordance with exemplary embodiments of the present invention. Before turning to description of FIGS. 4-6, it is noted that the flow diagrams shown therein are described, by way of example, with reference to components shown in FIGS. 1A-3, although these operational steps may be carried out in any system and are not limited to the scenarios shown in the aforementioned figures. Additionally, the flow diagrams in FIGS. 4-6 show examples in which operational steps are carried out in a particular order, as indicated by the lines connecting the blocks, but the various steps shown in these diagrams can be performed in any order, or in any combination or sub-combination. It should be appreciated that in some embodiments some of the steps described below may be combined into a single step. In some embodiments, one or more additional steps may be included.

Typically, when a new node needs to be added to a pre-existing cluster referred to herein as managed infrastructure 102 one of the most challenging tasks is to bootstrap (boot) new node, or to start up new computer node into a working state. Since many computer nodes need to be booted in a typical cloud-based data center 102, according to an embodiment of the present invention, one solution is to utilize a PXE booting environment. PXE booting allows a new node to boot without having to physically insert a boot disk into the machine or have an operating system already installed. PXE booting relies on the functionality of the Dynamic Host Configuration Protocol (DHCP) and Trivial File Transfer Protocol (TFTP) to send a small software boot image down to the network interface card of new nodes. DHCP is used by a new node to locate a boot server, such as seed node 304, from which the new node will receive the software boot image. Additionally, TFTP is used to actually download the software boot image. If PXE booting is carried out on a managed infrastructure 102 filled with many nodes, a system administrator may perform unattended operating system installs on each node simultaneously saving the system administrator from having to install an operating system on each individual node.

Referring now to FIG. 4, FIG. 4 depicts a flowchart of operational steps of the infrastructure manager component 202 of FIGS. 2A and 2B in accordance with an exemplary embodiment of the present invention. Infrastructure manager 202 is a component configured to manage both interaction between the components 202-205 and interaction with the managed infrastructure 102. According to an illustrative embodiment of the present invention, when a new node such as a physical system (e.g., server) gets delivered to a data center to be dynamically provisioned with a specific predetermined infrastructure, datacenter technicians typically place it on a rack, attach cables, switch power on, and so forth. Once the new node is powered on it may send a PXE boot image request to infrastructure manager 202 running on the seed node 304. In response, at 402, infrastructure manager 202 preferably performs remote initialization of a new node. In an embodiment of the present invention, this remote initialization may be accomplished by infrastructure manager 202 sending an agent boot image to the new node. In addition, at 402, the infrastructure manager 202 may receive a boot confirmation from the new node which indicates that the newly installed node booted successfully.

At 404, infrastructure manager 202 may determine whether the newly installed node has been pre-configured. The term “newly installed node” should be understood as a node being physically installed and configured within the managed infrastructure 102. This step may be necessary at least in some embodiments because infrastructure manager 202 is not initially aware of the configuration of the newly installed node.

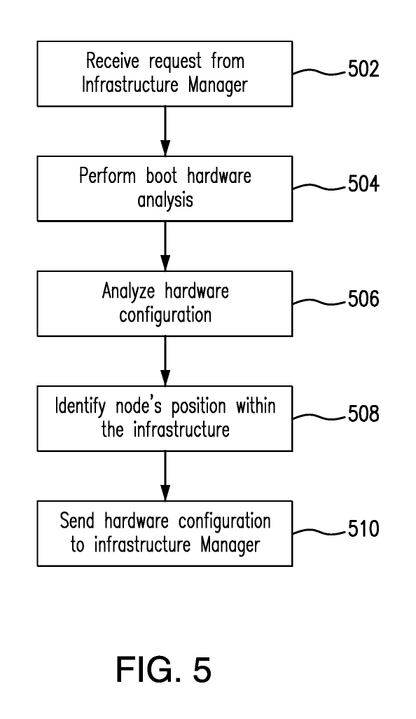

In response to determining that the newly installed node has been pre-configured (step 404, yes branch), at 405, the infrastructure manager 202 may terminate the automatic configuration process, for example, by sending a request to the newly installed node to restart in a normal boot fashion and enter a normal operation mode. If the infrastructure manager 202 determines that the newly installed node needs to be configured (step 404, no branch), at 406, the infrastructure manager 202 may send a request to hardware analyzer component 203 to perform hardware analysis of the newly installed node. Detailed description of operational steps of the hardware analyzer component 203 is provided below in reference to FIG. 5.

Once hardware analyzer 203 provides configuration information related to the newly installed node, at 408, the infrastructure manager 202 preferably stores received information in one or more databases. As previously indicated, IaaS management software 200 can be associated with a change and configuration management database, such as database 210 depicted in FIGS. 2A and 2B. According to an embodiment of the present invention, the configuration management database 210 may be located on one or more seed nodes 304. At least in some embodiments, the configuration management database 210 may comprise a distributed database. The term “configuration management database” should be understood as a repository of information related to all the components of a managed infrastructure 102. The configuration management database 210 includes configuration settings for the computing resources of a particular data center or a set of data centers managed by the IaaS management software 200. The configuration settings include attributes and relationships for each computing node and between the computing nodes. For example, a configuration setting may state that within data center X, computing node Y and Z are to communicate using Protocol P, where Y and Z define a relationship and P is an attribute of that relationship. It is noted that just because the term “configuration management database” includes the word database, this is not to imply that the configuration management database 210 has to be a relational database or any database for that matter. That is, the configuration management database 210 can be any repository of information where that repository can be directory based, database based, file based, table based, or a combination thereof.

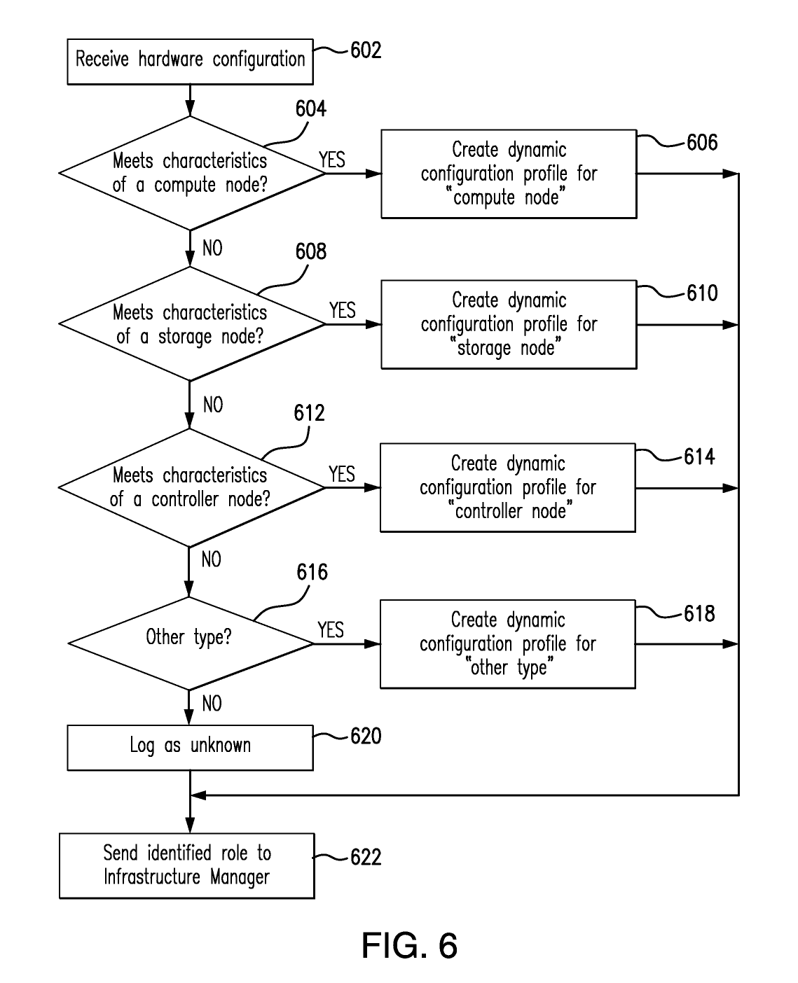

According to an embodiment of the present invention, at 410, the infrastructure manager 202 may send newly installed node's configuration details to role manager component 204 to procedurally identify a role for the newly installed node based, for example, on its configuration. In addition to determining a role for the newly installed node, according to an embodiment of the present invention, the role manager component 204 may generate a dynamic configuration template corresponding to the newly installed node. Detailed description of operational steps of the role manager component 204 is provided below in reference to FIG. 6.

At 412, the infrastructure manager 202 preferably receives the role associated with the newly installed node as determined by the role manager 204. Next, at 414, the infrastructure manager 202 may also load the dynamic configuration template generated by the role manager 204 from the configuration management database 210, for example. According to an embodiment of the present invention, the dynamic configuration template may be inferred from the newly installed node's hardware configuration. Various nodes within the managed infrastructure may be configured by means of dynamic configuration template (or dynamic configuration file). A dynamic configuration template may comprise a file containing text and/or other information regarding various configuration settings. Instead of conventional static configuration values, the dynamic configuration template defines dynamic elements/setting to reflect any role assigned to the node. The dynamic elements may include parameters that characterize each node that receives the configuration. Parameters may include, but are not limited to, inferred host names, instance names, the number of CPUs, the amount of available memory, and other hardware and software elements. In an embodiment of the invention, the role manager 204 adapts the dynamic configuration template to the specific domain of the managed infrastructure 102 based on a predetermined set of characteristics.

At 416, the infrastructure manager 202 may selectively configure various hardware/software elements specific to the newly installed node based on the dynamic configuration template. For example, this step may involve the infrastructure manager 202 executing one or more installation and configuration scripts that may be generated and customized based on the dynamic configuration template. In one embodiment of the present invention, a script is a list of commands that can be executed to support various functions related to node configuration/provisioning. Once the infrastructure manager 202 completes hardware/software configuration, it may perform one or more validation tests to ensure proper installation and to ensure that all installed components are operating properly on the newly installed node.

If the infrastructure manager 202 determines that the newly installed node failed validation tests more than once (step 418, no branch), the infrastructure manager 202 may return back to step 404 and selectively perform one or more of the above described steps 404-416 to fix any configuration/installation issues that prevent the newly installed from passing the validation test. In response to determining that the newly installed node successfully passed one or more validation tests (step 418, yes branch), at 420, the infrastructure manager 202 may complete the automatic configuration process by remotely rebooting the newly installed node by various means described above and by performing any type of post-installation software configuration, if necessary. Post installation configuration can consist of similar tasks across many applications, such as starting and stopping services, creating new database users and access control, creating new databases and populating them with default data, as well as many other tasks specific to a particular application/domain/data center. It is noted that one of the operational steps performed by the infrastructure manager 202 (not shown in FIG. 4) may include the infrastructure manager 202, in cooperation with the host name manager 205, dynamically assigning a descriptive name within the infrastructure namespace to the newly installed node, as described below.

Referring now to FIG. 5, FIG. 5 depicts a flowchart of operational steps of the hardware analyzer component 203 of FIGS. 2A and 2B in accordance with an exemplary embodiment of the present invention. Hardware analyzer 203 may be a component configured to analyze hardware configuration of various nodes 104 within the managed infrastructure 102. According to an illustrative embodiment of the present invention, once a new node completes remote initialization, the infrastructure manager 202 may send a request to analyze new node's hardware to the hardware analyzer 203. Accordingly, at 502, the hardware analyzer 203 may receive such request.

Next, at 504, the hardware analyzer 203 may perform a boot hardware analysis. According to an embodiment of the present invention, as part of the initialization procedure, the infrastructure manager 202 may send a small software boot image down to the new node using TFTP, for example. This boot image may include a software module referred to herein as a “mini operating system (OS)”. The mini OS provides minimal functionality, just sufficient for supporting the processor type of the new node. Typical size of the mini OS ranges from 500 KB-10 MB. An example of a mini OS in the PXElinux environment is the Linux® kernel, initial ramdisk, together with some utilities, selected from among the various system or application utilities known to those in the art. Key functionalities of the microkernel may be determining the hardware elements of the new node, using a suitable method, such as scanning the new node and creating information which typically consists of a list of all hardware components the new node is comprised of. Thus, at 504, the hardware analyzer 203 may employ the microkernel of the new node to perform a hardware scan.

At 506, the hardware analyzer 203 may further analyze the collected information. For example, the hardware analyzer 203 may evaluate the file generated as a result of the hardware scan at 504 to determine a number and type of processors, such as, for example, core processors included in the node being configured. This step may further involve determining an amount of allocated memory, such as RAM, and an amount and type of allocated storage space, such as, for example, disk storage space, or other storage space. In some embodiments, analyzing hardware configuration may include determining additional, or other, configuration information including, but not limited to, the number and type of adapter cards installed on the new node.

It is noted that many organizations have traditionally built computer operating environments such as data centers with arbitrary naming conventions that describe either the environment the system belongs to or information about their logical placement in a data center, but not both. Even when naming conventions are more functionally focused, they are usually not procedurally deterministic so that an operator or technician typically gets directly involved in the determination of the name, environment, or configuration within a specific infrastructure.

According to another aspect of the present invention, the method of building a managed infrastructure described herein may include a method of assigning names to different nodes and instances within the managed infrastructure in accordance with some organizational guidelines, which usually describe the node in terms of the role assigned to the node by the role manager component 204 and node's position/location within the managed infrastructure. As a non-limiting example, “prod-nj-db01.organizationdomain.com” name may describe a first instance of a database node located in New Jersey. As another example of a slightly modified convention, the name “1.emaildb.nj.organizationdomain.com” may be assigned to a node comprising a first instance of an email database server located in New Jersey. As yet another example, the name “email.dc01.organizationdomain.com” may indicate that this particular node comprises an email server located in a first data center. According to an embodiment of the present invention, such procedurally deterministic names may also include other hardware elements such as the switch number and port number associated with a given node. In other words, a node name may be represented, for example, as roleSN-PN.clustername.organizationdomain.com, where SN represents a switch number and PN represents a port number.

Referring back to FIG. 5, at 508, the hardware analyzer 203 may identify new node's position within the managed infrastructure, for example, by analyzing node names of the neighboring nodes located within the same cluster of the managed infrastructure 102 as the new node using a predetermined naming convention. According to one embodiment of the present invention, an InfiniBand architecture may be used for interconnecting nodes in managed infrastructure 102, such as cloud-based data centers, by providing a channel-based, switched-fabric technology. In such a configuration, data may be transmitted via messages which are made up of packets. Each node, whether processor or I/O, may include a channel adapter. The messages are typically transmitted from one node's channel adapter to another node's channel adapter via switches. In such embodiment, step 508 may involve the hardware analyzer 203 performing the InfiniBand discovery process, such that the hardware analyzer 203 interoperates with all standard InfiniBand components/nodes of the managed infrastructure 102. It is noted that various embodiments of the present invention are not limited to InfiniBand architecture and contemplate usage of any suitable architecture for interconnecting nodes in a clustered environment. At 510, the hardware analyzer 203 preferably transmits information obtained at steps 504-508, including new node's physical location within the managed infrastructure, to infrastructure manager component 202.

Referring now to FIG. 6, FIG. 6 depicts a flowchart of operational steps of the role manager component 204 of FIGS. 2A and 2B in accordance with an exemplary embodiment of the present invention. Role manager 204 is a component configured to infer a role of the newly deployed node based on its configuration and according to predefined node configuration criteria, for example. According to an illustrative embodiment of the present invention, once the hardware analyzer 203 completes its comprehensive hardware scan and passes collected information to the infrastructure manager 202, the infrastructure manager 202 may send a role determination request to role manager 204. This role determination request preferably contains new node's configuration information. Accordingly, at 602, the role manager 204 may receive such request.

In an embodiment of the present invention, the role manager 204 may also employ a master template, representing desired attributes and characteristics of various nodes within the managed infrastructure 102, for role determination of a newly installed node. Such template may be stored, for example, in a data center model database. The master template may include information such as types of nodes to be configured (i.e., compute node, storage node, controller node, and the like), specific characteristics (i.e., number of processors, storage drives, etc.) of each node type, and so on. This master template can be customized for each particular cluster to take into account cluster-specific needs and/or constraints. According to an embodiment of the present invention, the role manager 204 may evaluate the master template in order to generate a decision tree corresponding to the template. As an illustrative non-limiting example, if the master template includes three different types of nodes mentioned above, the generated decision tree will include one or more decision associated with each node type. It is noted that steps 604-618 described below represent an exemplary decision tree simplified for illustration purposes only.

At 604, the role manager 204 may analyze the received newly installed node's configuration to determine whether it meets characteristics of a compute node. For example, the role manager 204 may determine whether the new node has required processing power of a compute node. Thus, if the role manager 204 determines that the newly installed node meets specified characteristics (i.e., having at least 24 core processors) of a compute node (step 604, yes branch), the role manager 204 may assign a corresponding role to this new node at 606. According to an embodiment of the present invention, in addition, the role manager 204 may be configured to dynamically generate a dynamic configuration profile and/or dynamic configuration script associated with each type of node being configured.

It is noted that various embodiments of the present invention may be applied to managed infrastructure 102 having any sort of software platform, such as Windows systems, UNIX systems, and Linux systems among many others. For purposes of illustration, an embodiment of the present invention will now be explained with reference to implementation to Linux systems, such as Fedora and Red Hat Enterprise Linux by Red Hat, Inc. Currently, there are several automation frameworks available that support hardware and software provisioning. In one embodiment, the present invention may be applied to Anaconda-based Linux managed infrastructure 102. In such embodiment, the role manager 204 may employ what is known as “kickstart” files. Kickstart files are files that specify the intended configuration of the hardware/software being provisioned. The kickstart file is a simple text file, containing a list of items, each identified by a keyword. In general, a kickstart file can be edited with any text editor or word processor that can save files as ASCII text. Typically, kickstart files specify parameters related to: language selection; mouse configuration; keyboard selection; disk partitioning; network configuration; NIS, LDAP, Kerberos, Hesiod, and Samba authentication; firewall configuration; and the like. One skilled in the art will recognize that embodiments of the present invention may be applied to non-kickstart files in Linux provisioning. For example, configuration files, such as AutoYAST Answer files used in Novell SuSe Linux and Sun Solaris Jumpstart files, may also be used by various embodiments of the present invention. Furthermore, the role manager 204 may employ any suitable Windows-based automation framework as well.

Referring back to Linux-based automation framework, at 606, the role manager 204 may also create a dynamic configuration profile for a compute node. For example, the role manager 606 may amend the dynamically built configuration file with specific configuration parameters related to a compute node.

In response to determining that newly installed node's configuration does not meet characteristics of a compute node (step 604, no branch), at 608, the role manager 204 may determine whether newly installed node's configuration meets characteristics of a storage node. For example, the role manager 204 may check whether the new node's configuration includes a specified number of storage disks. If so (step 608, yes branch), at 610, the role manager 204 may make a determination that the newly installed node should be a storage node. In addition, the role manager 204 may create a dynamic configuration profile for a storage node. For example, the role manager 204 may amend the dynamically built configuration file with specific configuration parameters related to a storage node.

In response to determining that newly installed node's configuration does not meet characteristics of a storage node (step 608, no branch), at 612, the role manager 204 may determine whether newly installed node's configuration meets characteristics of a controller node. If so (step 612, yes branch), at 614, the role manager 204 may assign a corresponding role to the newly installed node and may create a dynamic configuration profile for a controller node. For example, the role manager 204 may amend the dynamically built configuration file with specific configuration parameters related to a controller node.

It is noted that the role manager 204 may continue this automatic inference process for each node type included in the master template according to a generated decision tree. In other words, if the master template specifies other types of nodes the role manager 204 may continue comparing newly installed node's configuration with specified characteristics of each type of node until it finds a match. Advantageously, in response to finding such match (step 616, yes branch), the role manager 204, at 618, creates a corresponding dynamic configuration profile and/or modifies the configuration file accordingly.

According to an embodiment of the present invention, if newly installed node's hardware configuration does not match any of the node types specified in the master template, at 620, the role manager 204 may log a corresponding error message in the configuration database 210. Alternatively, the role manager 204 may send a suitable response back to the infrastructure manager 202.

At 622, the role manager 204 may complete the determination of a new node's role by sending its decision (i.e., a role that should be assigned to the newly installed node) along with the dynamic configuration template and/or dynamically configured configuration file to the infrastructure manager 202, as described above.

In summary, an improved method to procedurally and automatically build a modular systems infrastructure with a dynamic namespace is provided herein. This highly scalable method permits the managed infrastructure to be modular. “Highly scalable” means that it can scale from a few nodes and a handful of drives to thousands of nodes and dozens of Petabytes of storage. In such an environment new nodes can be added to the cluster without downtime and without requiring highly skilled resources to perform the setup and configuration of the managed hardware and software.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

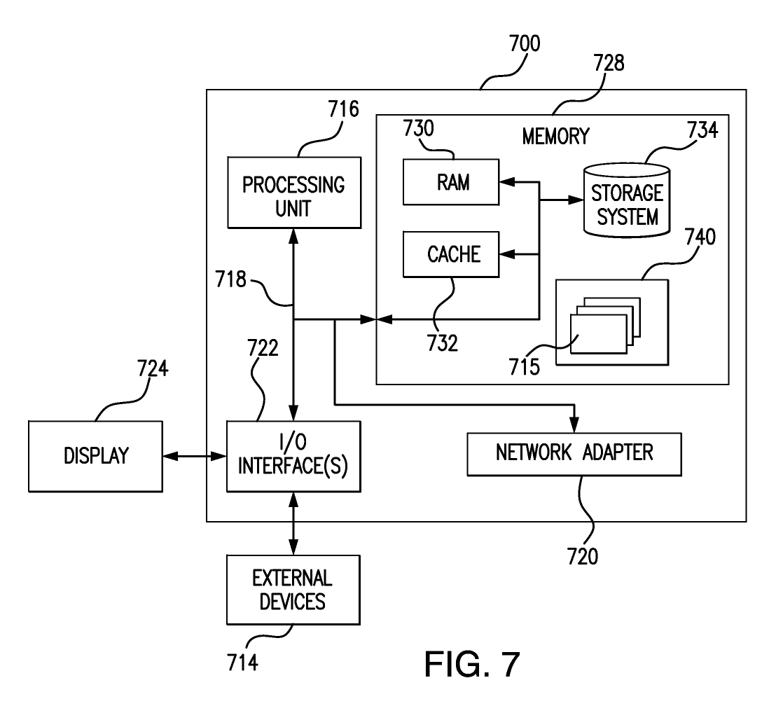

FIG. 7 is a schematic block diagram of an example network computing device 700 (e.g., seed node) that may be used (or components thereof) with one or more embodiments described herein. As explained above, in different embodiments these various devices are configured to communicate with each other in any suitable way, such as, for example, via communication network 100.

Device 700 is intended to represent any type of computer system capable of carrying out the teachings of various embodiments of the present invention. Device 700 is only one example of a suitable system and is not intended to suggest any limitation as to the scope of use or functionality of embodiments of the invention described herein. Regardless, computing device 700 is capable of being implemented and/or performing any of the functionality set forth herein.

Computing device 700 is operational with numerous other general purpose or special purpose computing system environments or configurations. Examples of well-known computing systems, environments, and/or configurations that may be suitable for use with computing device 700 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing device 700 may be described in the general context of computer system-executable instructions, such as program modules, being executed by a computer system. Generally, modules may be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several storage devices. Similarly, operational data may be identified and illustrated herein within modules, and may be embodied in any suitable form and organized within any suitable type of data structure. The operational data may be collected as a single data set, or may be distributed over different locations including over different storage devices.

Computing device 700 may be practiced in distributed data processing environments where tasks are performed by remote processing devices that are linked through a communications network. In a distributed data processing environment, program modules may be located in both local and remote computer system storage media including memory storage devices.

Device 700 is shown in FIG. 7 in the form of a general-purpose computing device. The components of device 700 may include, but are not limited to, one or more processors or processing units 716, a system memory 728, and a bus 718 that couples various system components including system memory 728 to processor 716.

Bus 718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, and Peripheral Component Interconnect Express (PCIe) bus.

Computing device 700 typically includes a variety of computer system readable media. Such media may be any available media that is accessible by device 700, and it includes both volatile and non-volatile media, removable and non-removable media.

System memory 728 can include computer system readable media in the form of volatile memory, such as random access memory (RAM) 730 and/or cache memory 732. Computing device 700 may further include other removable/non-removable, volatile/non-volatile computer system storage media. By way of example only, storage system 734 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 718 by one or more data media interfaces. As will be further depicted and described below, memory 728 may include at least one program product having a set (e.g., at least one) of program modules that are configured to carry out the functions of embodiments of the invention.

Program/utility 740, having a set (at least one) of program modules 715, such as infrastructure manager 102, hardware analyzer 103, role manager 104 and hostname manager 105 described above, may be stored in memory 728 by way of example, and not limitation, as well as an operating system, one or more application programs, other program modules, and program data. Each of the operating system, one or more application programs, other program modules, and program data or some combination thereof, may include an implementation of a networking environment. Program modules 715 generally carry out the functions and/or methodologies of embodiments of the invention as described herein.

Device 700 may also communicate with one or more external devices 714 such as a keyboard, a pointing device, a display 724, etc.; one or more devices that enable a user to interact with computing device 700; and/or any devices (e.g., network card, modem, etc.) that enable computing device 700 to communicate with one or more other computing devices. Such communication can occur via Input/Output (I/O) interfaces 722. Still yet, device 700 can communicate with one or more networks such as a local area network (LAN), a general wide area network (WAN), and/or a public network (e.g., the Internet) via network adapter 720. As depicted, network adapter 720 communicates with the other components of computing device 700 via bus 718. It should be understood that although not shown, other hardware and/or software components could be used in conjunction with device 700. Examples, include, but are not limited to: microcode, device drivers, redundant processing units, external disk drive arrays, RAID systems, tape drives, and data archival storage systems, etc.

FIG. 7 is intended to provide a brief, general description of an illustrative and/or suitable exemplary environment in which embodiments of the above described present invention may be implemented. FIG. 7 is exemplary of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer-implemented method for managing a cluster of nodes in a networked system, the method comprising the steps of:
detecting, by a processor, the presence of a new node as it is added into the networked cluster;
automatically determining, by a processor, a hardware configuration of the new node;
assigning, by a processor, a role to the new node based on the determined new node's configuration and according to predefined node configuration criteria; and
selectively configuring, by a processor, the new node based on the assigned role.

2. The computer-implemented method of claim 1, further comprising performing one or more validation tests of the new node after said selective configuration.

3. The computer-implemented method of claim 1, wherein the step of selectively configuring the new node further comprises generating one or more configuration scripts, wherein the one or more configuration scripts include a plurality of configuration parameters and settings related to the assigned role of the new node.

4. The computer-implemented method of claim 1, further comprising dynamically assigning a name to the new node according to a predefined node naming convention, wherein the assigned name is indicative of the new node's role and indicative of new node's physical location within the networked system.

5. The computer-implemented method of claim 1, further comprising, after said step of automatically determining a hardware configuration of the new node, the processor storing the new node configuration in a configuration management repository.

6. The computer-implemented method of claim 1, wherein said cluster of nodes comprises a cloud computing environment.

7. The computer-implemented method of claim 1, wherein said cluster of nodes comprises software defined scalable data center.

8. The computer-implemented method of claim 1, further comprising, after said step of automatically determining a hardware configuration of the new node, the processor identifying a position of the new node within the networked cluster based on analysis of information related to one or more adjacent nodes within the networked cluster.

9. The computer-implemented method of claim 1, wherein the assigned role comprises at least one of a compute node, storage node or controller node.

10. The computer-implemented method of claim 9, wherein the new node is assigned the storage node role in response to determining that the new node's configuration includes a predetermined number of storage disks.

11. The computer-implemented method of claim 1, further comprising, after said step of detecting the presence of the new node, the processor performing remote initialization of the new node in response to receiving a Preboot eXecution Environment (PXE) boot image request from the new node.

12. A system for distributed management of a cluster of nodes, the system comprising:
a network configured to communicate data between a plurality of nodes;
one or more new nodes in communication with the network;
one or more cluster management nodes in communication with the network, the one or more cluster management nodes comprising:
a hardware analyzing module configured to analyze hardware configurations of the plurality of nodes and hardware configurations of the one or more new nodes;
a role managing module configured to determine at least one role for the one or more new nodes based on the configurations of the one or more new nodes; and
a naming module configured to dynamically assign a descriptive name to the one or more new nodes based at least in part on the at least one role assigned to the one or more new nodes.

13. The system of claim 12, wherein the one or more cluster management nodes further comprises a configuration managing module configured to selectively configure the one or more new nodes based on the at least one assigned role.

14. The system of claim 13, wherein the configuration managing module is further configured to perform one or more validation tests of the one or more new nodes after said selective configuration.

15. The system of claim 13, wherein the configuration managing module utilizes one or more user-configurable configuration scripts and wherein the one or more configuration scripts include a plurality of configuration parameters and settings related to the at least one assigned role of the one or more new nodes.

16. The system of claim 12, wherein the descriptive name is assigned to the one or more new nodes according to a predefined node naming convention and wherein the assigned name is indicative of the at least one role and indicative of one or more node's physical location within the cluster of nodes.

17. The system of claim 12, wherein the one or more cluster management nodes further comprise a configuration management repository for storing the configuration information related to the plurality of nodes and wherein the plurality of nodes includes the one or more new nodes.

18. The system of claim 12, wherein the hardware analyzing module, the role managing module and the naming module are distributed among the cluster management nodes.

19. The system of claim 14, wherein the configuration managing module is further configured to remotely reboot the one or more new nodes in response to determining that the one or more new nodes successfully passed the one or more validation tests.

20. A computer program product for distributed management of a cluster of nodes, the computer program product comprising:
a computer readable storage device to store a plurality of program instructions, wherein the plurality of program instructions, when executed by a processor within one or more cluster management nodes, causes the one or more cluster management nodes to perform operations of a plurality of modules, the modules comprising:
a hardware analyzing module configured to analyze hardware configurations of one or more new nodes within a plurality of managed nodes;
a role managing module configured to determine at least one role for the one or more new nodes based on the analyzed configurations of the one or more new nodes;
a naming module configured to dynamically assign a descriptive name to the one or more new nodes based at least in part on the at least one role assigned to the one or more new nodes; and
a configuration managing module configured to selectively configure the one or more new nodes based on the at least one assigned role.
